(19) United States
(12) Patent Application Publication
(10) Pub. No.: US 2008/0202888 A1
(43) Pub. Date: Aug. 28, 2008

(54) Controllable surface system

(76) Inventor: Ka-Ming Lai, Fremont, CA (US)

Correspondence Address: KA-MING LAI, 4724 WHEELER DR., FREMONT, CA, 94538, US

(21) Appl. No.: 11/711,991

(22) Filed: Feb. 28, 2007

(51) Int. Cl. B65G 13/00

(52) U.S. Cl. 193/35 R

(57) ABSTRACT

A controllable surface system comprises a platform providing a system surface and a controlling device for controlling the platform and adjusting the surface friction between slippery and non-slippery.

### BACKGROUND OF THE INVENTION

1. Field of the Invention

The present invention relates, in general, to a surface system. More particularly, the present invention relates to a controllable surface system capable of controlling and adjusting its surface between slippery and non-slippery.

2. Background of the Invention

Vehicle trunks usually have a slippery surface. With the slippery surface, passengers may load luggage or items thereupon, and easily move around or unload them from the slippery surface. However, when the vehicle is in motion, the placed luggage or items may slide and shift around inside the trunk.

To prevent items from sliding and shifting around, anti-slip mats may be used to provide a non-slippery surface. However, with such anti-slip mats, it becomes difficult to move or unload luggage or items from the mats due to high friction of the anti-slippery mats.

### BRIEF SUMMARY OF THE INVENTION

One example consistent with the invention provides a controllable surface system which comprises a platform providing a system surface and a controlling device for controlling the platform and adjusting the system surface between slippery and non-slippery.

Another example consistent with the invention provides a controllable surface system which comprises a platform providing a system surface. The platform comprises a first layer with a number of rolling device, each rolling device having a covering to provide the system surface. The surface system also comprises a controlling device for controlling rotation of the rolling devices to adjust the system surface between slippery and non-slippery.

In another example, a controllable surface system comprises a platform providing a system surface. The platform comprises a first layer having a number of first opening areas, a second layer having a number of second opening areas, and a number of rolling devices positioned between the first opening areas of the first layer and the second opening areas of the second layer. Each rolling device has a first friction covering and is capable of turning around. At least a part of one of the rolling devices exposes from the first layer to provide the system surface. The surface system also comprises a controlling device for controlling rotation of at least one of the rolling devices to adjust the system surface between slippery and non-slippery.

Another example consistent with the invention provides a controllable surface system which comprises a platform providing a system surface with a surface friction. The platform comprises a first layer with a first friction having a number of opening areas, and a second layer having a number of devices in positions corresponding to locations of the opening areas of the first layer. Each device has a surface with a second friction. The surface system also comprises a controlling device for controlling the second layer so that at least one of the devices is exposed from the open areas of the first layer, thereby adjusting the surface friction of the system surface.

In another example, a controllable surface system comprises a platform providing a system surface with a surface friction. The surface friction is adjusted in accordance with application of external influences. The surface system also comprises a controlling device for controlling an amount of the external influences that applies to the platform

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended, exemplary drawings. It should be understood, however, that the invention is not limited to the precise arrangements and instrumentalities shown. The drawings are briefly described as follows:

FIGS. 1(a) and 1(b) are an exemplary controllable surface system in examples consistent with the present invention;

FIGS. 2(a) and 2(b) are an exemplary controllable surface system in examples consistent with the present invention;

FIG. 3(a) is an exemplary layer of FIGS. 2(a) and 2(b) in examples consistent with the present invention;

FIG. 3(b) is an exemplary layer of FIGS. 2(a) and 2(b) in examples consistent with the present invention;

FIGS. 4(a)-4(e) are exemplary devices of FIGS. 2(a) and 2(b) in examples consistent with the present invention;

FIG. 5(a) is an exemplary controllable surface system in examples consistent with the present invention; and

FIG. 5(b) is an exemplary device of FIG. 5(a) in examples consistent with the present invention.

### DETAILED DESCRIPTION OF THE INVENTION

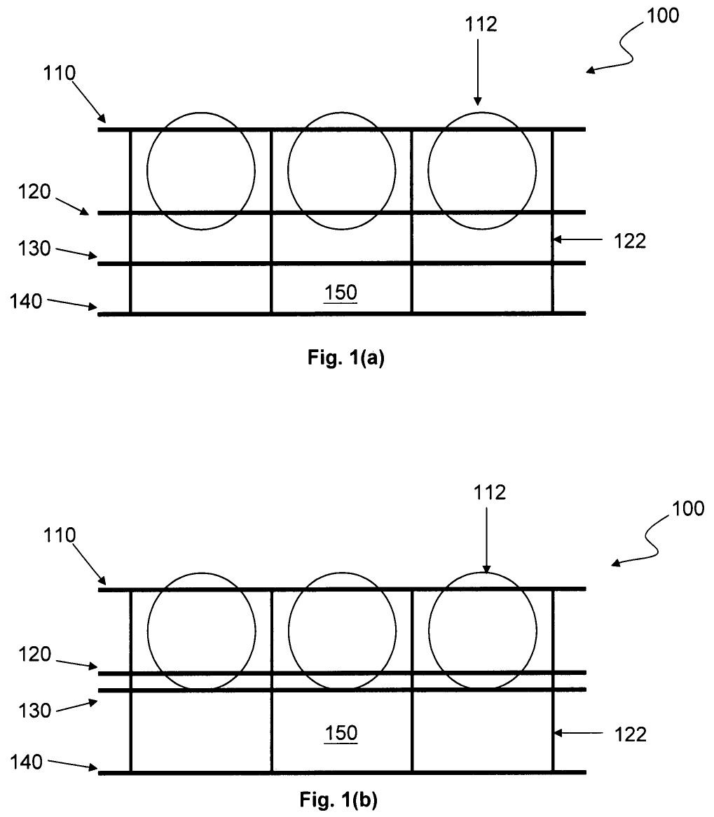

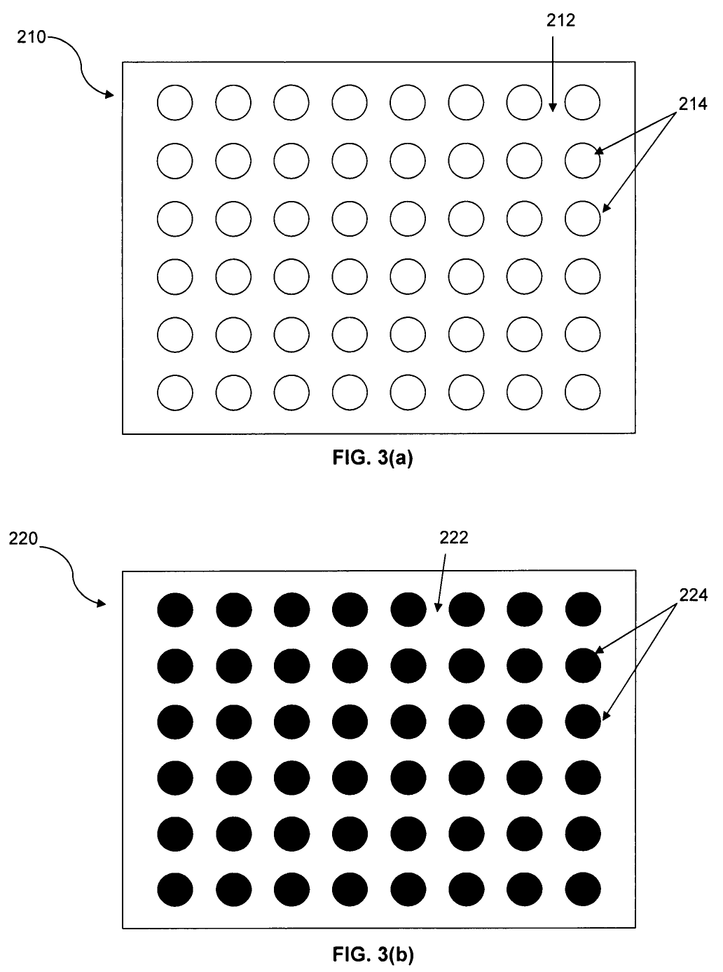

The present invention is a controllable surface system in which the surface system may be adjusted under control of a controlling device between slippery and non-slippery. FIG. 1(a) illustrates an exemplary controllable surface system in examples consistent with the present invention. Referring to FIG. 1(a), a surface system 100 includes four layers 110, 120, 130 and 140 and a number of rolling devices 112 such as ball bearings. The four layers 110, 120, 130 and 140 are made of materials, such as hard metals or metal alloys. In one example, the top of the third layer is coated with high friction materials, such as rubber. The first and the second layers have a number of openings or holes as shown at FIG. 3(a) so that the rolling devices 112 may be positioned between the first and the second layers as shown at FIG. 1(a) and be partially exposed from the first layer 110 to contact objects that are placed thereupon. In one example, the rolling devices 112 may be made of steels and be coated with high friction materials, such as rubber. The movable devices 112 may be of different sizes.

A number of support beams 122 are coupled to each of the four layers 110, 120, 130 and 140. The first, second and the fourth layers may be fixedly coupled to the support beams 122 so that the distances between the first layer 110 and the second layer 120 and between the second layer 120 and the fourth layer 140 remain the same throughout the operation. The third layer 130 may be movable along the support beams 122 under control of a controlling device 150. In one example, the controlling device 150 may be a hydraulic system located between the third layer 130 and the fourth layer 140. In another example, the controlling device 150 may be a mechanical system to control and move the third layer 130.

The controlling device 150 may control the third layer 130 moving up toward the second layer 120 or moving down toward the fourth layer 140. When the third layer 130 does not contact with the rolling devices 112 as shown at FIG. 1(a), the rolling devices 112 may freely rotate and any object placed on the devices 112 may freely move around due to the rotation of the devices 112. When the third layer 130 moves up and, with application of force, contacts with the rolling devices 112 as shown at FIG. 1(b), the devices 112 are prevented from turning around. As a result, the objects placed on the devices 112 cannot be easily moved around. The degree of slipperiness may depend on the amount of force being applied to the rolling devices 112. In this manner, with the controlling device 150, a user or system operator may choose to have a slippery surface or a non-slippery surface at will. In another example, the third layer 130 may be divided into a number of sections, each section being controlled by the controlling device to move up and down. Thus, this design allows a user or system operator to control and adjust a particular area of the system surface between slippery and non-slippery.

In another example in consistent with the present invention, the surface system 100 may have a first layer with associated rolling devices and a second layer to be controlled by a controlling device. The rolling devices may be made of or coated with high friction materials, such as rubber. The controlling device may control the second layer to contact with the rolling devices so as to prevent the rolling devices from turning around, thereby providing a non-slippery surface.

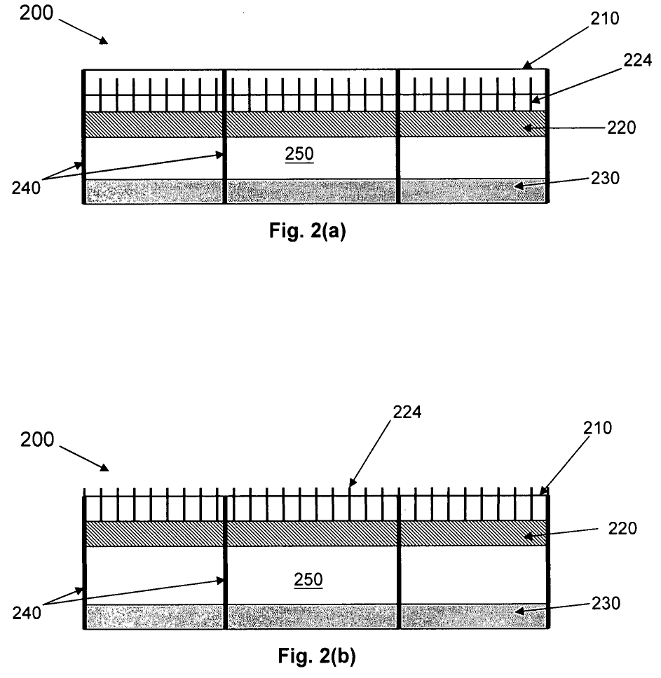

FIG. 2(a) illustrates an exemplary controllable surface system in examples consistent with the present invention. Referring to FIG. 2(a), a surface system 200 includes a first layer 210, a second layer 220 and a third layer 230. An exemplary first layer 210 is illustrated at FIG. 3(a) where the surface 212 provides a first surface friction. In one example, the surface 212 of the first layer 210 may be made of low friction materials, such as polytetrafluoroethylene (PTFE) coating materials or highly polished stainless steels to provide a slippery or smooth surface with low friction. As shown at FIG. 3(a), there are a number of through holes or open areas 214 on the first layer 210. The through holes or open areas 214 may be of different sizes and/or different shapes.

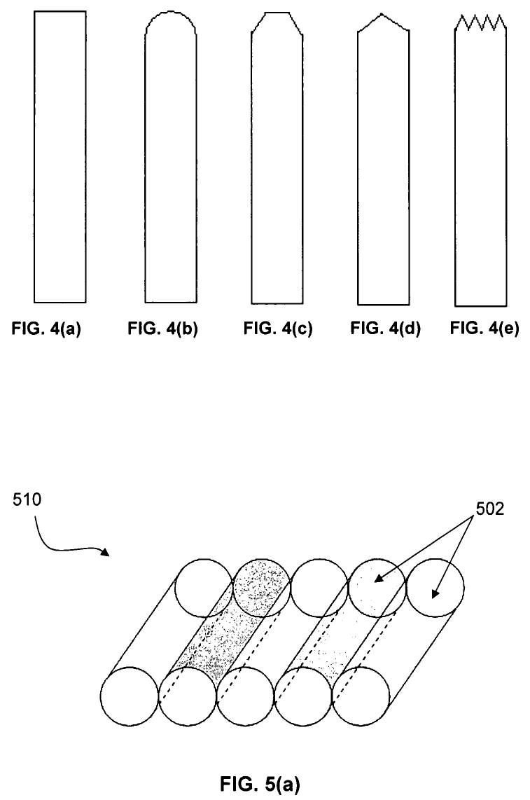

FIG. 3(b) shows an exemplary second layer 220 which has a surface 222 with a second surface friction. In one example, the second layer 220 may be in the same size or different size as the first layer 210. On the positions corresponding to the open areas 214, the second layer 220 has a number of devices 224 positioned thereon, such as sticks, protruded elements or ball bearings. Devices 224 may be in any shape or in a shape configured to fit the corresponding through hole and open area 214. The length of each device 224 may be slightly longer than the thickness of the first layer 210. A device 224 may have a flat surface or a specific shaped surface on the top end of the device 224 as shown at FIG. 4(a)-(e) in examples consistent with the present invention. In one example, the surface of each device 224 may be made of high friction materials, such as rubber. In an exemplary position, devices 224 may partially fit into through holes or open areas 214 as shown at FIG. 2(a). In another exemplary position, devices 224 may extend through through holes or open areas 214 as shown at FIG. 2(b) so that devices 224 surface outside the first layer 210.

Referring again to FIG. 2(a), the third layer 230 may be made of metals or any hard material, such as steel. A number of support beams 240 are coupled to each of the three layers 210, 220 and 230. The third layer 230 and support beams 240 may provide support for receiving the weight of objects placed upon the first layer 210. The first layer 210 and the third layer 230 may be fixedly coupled to support beams 240 so that the distance between the first layer 210 and the third layer 230 remains the same throughout the operation. The second layer 220 may be movable along the support beams 240 under control of a controlling device 250.

In one example, the controlling device 250 may be a hydraulic system located between the second layer 220 and the third layer 230. In another example, the controlling device 250 may be a mechanical system for control of the second layer 220. The controlling device 250 may control the second layer 220 moving up toward the first layer 210 or moving down toward the third layer 230. While the second layer 220 moves up toward the first layer 210, devices 224 extend through through holes or open areas 214 as shown at FIG. 2(b). Because one end of each device 224 surfaces outside the first layer 210, the surface of devices 224 would contact the items placed on the system 200 and provide higher surface friction. In the manner of controlling the second layer 220 and the devices 224, the surface friction of the system 200 may be adjustable depending on how much the devices 224 extend through through-holes and open areas 214.

In one example consistent with the present invention, the surface 212 of the first layer 210 may be made of high friction materials, such as rubber, and the top surface of the devices 224 may be made of low friction materials, such as PTFE coating materials or highly polished stainless steels to provide smooth surface with low friction. In this manner, when the second layer 220 moves toward the first layer 210 and devices 224 extend through through holes or open areas 214, the surface of devices 224 would contact the items placed on the system 200 and provides a low friction surface.

In another example consistent with the present invention, the controlling device 250 may control each individual device 224. In this manner, the more devices 224 move up to contact with the placed items, the higher friction the system 210 may provide. Thus, this design allows a user or system operator to control the friction of a particular area of the system surface.

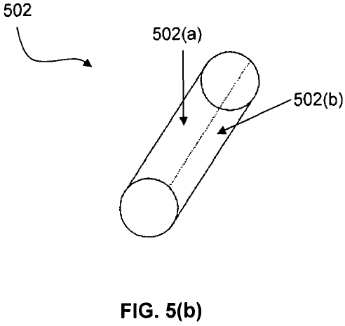

FIG. 5(a) illustrates another exemplary controllable surface system in consistence with the present invention. With reference to FIG. 5(a), the controllable surface system includes a platform 510. The platform 510 may include a number of rolling elements 502. Shown at FIG. 5(b) is an exemplary rolling element which may be coated with at least two different materials providing different degrees of surface friction. In one example, a covering area 502(a) of a rolling element 502 is made of low friction material, such as PTFE coating materials or highly polished stainless steel to provide smooth surface with low friction. A covering area 502(b) of the rolling element 502 may be made of high friction materials, such as rubber, to provide high friction. The system may also include a controlling device to control the element 502 and adjust the surface friction of the system. The controlling device may be a mechanical system to control rotation of each individual element so that the area contacted with the items placed thereupon (i.e., the contacting area) may be changed from low friction covering area to the high friction covering area. In operation, the more high friction contacting areas are provided to contact the objects placed upon, the higher friction is for the system surface. In this manner, a user or system operator may control the controlling device to adjust the surface friction of the system.

In another embodiment in consistence with the present invention, the surface friction of a controllable surface system having a platform may be adjustable in accordance with the degree of energy applies to the platform. In one example, the platform may be made of a material such that when electrical current applies, the surface friction of the platform changes from one degree to another. The degree of the surface friction may depend on how much electrical current applies to the platform. In another example, the platform may be made of a material such that when heat applies, the surface friction of the platform changes from one degree to another. The surface friction may depend on the amount of heat applies to the platform. Another example is that the platform made of a material such that when electromagnetic field applies, the surface friction of the platform changes from one degree to another. The degree of the surface friction may depend on the intensity of electromagnetic field applies to the platform. The controllable surface system may include a controlling device for controlling the amount of the external influences to apply to the platform to change the degree of surface friction.

The above exemplary controllable surface systems in consistent with the present invention may be applied to different applications where the systems are required to provide smooth surface and high friction surface alternately. Examples may include object transports (including automobiles, aircrafts, vessels), warehouse management and factory conveyor belts in manufacturing processes among other different applications. With a controllable surface systems in consistent with the present invention, cargos or objects may be loaded and uploaded easily. In addition, by making particular areas of the system with low friction and other areas in high friction, cargos and objects may be moved or transported in a desired path. In another example, a surface system in consistent with the present invention may be applied to the bottom of an object. In this application, the bottom surface of the object may be changed to low friction for easily moving around or changed to high friction for preventing the object from moving. In a further example, a surface system in consistent with the present invention may be applied to side surfaces of an object as well.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A controllable surface system, comprising:
a platform providing a system surface; and
a controlling device for controlling the platform and adjusting the system surface between slippery and non-slippery.

2. The surface system of claim 1, wherein the controlling device is one of a hydraulic system and a mechanical system.

3. A controllable surface system, comprising:
a platform providing a system surface, wherein the platform comprises a first layer with a number of rolling devices, wherein each rolling device having a covering to provide the system surface; and
a controlling device for controlling rotation of the rolling devices to adjust the system surface between slippery and non-slippery.

4. The surface system of claim 3, wherein the platform further comprises a second layer, wherein the controlling device is for controlling the second layer to contact with the rolling devices to prevent at least one of the rolling devices from turning around, thereby adjusting the system surface between slippery and non-slippery.

5. The surface system of claim 3, wherein the controlling device is one of a hydraulic system and a mechanical system.

6. A controllable surface system, comprising:
a platform providing a system surface, wherein the platform comprises:
a first layer having a number of first opening areas;
a second layer having a number of second opening areas;
a number of rolling devices positioned between the first opening areas of the first layer and the second opening areas of the second layer, each rolling device capable of turning around and having a covering with a first friction, wherein at least a part of one of the rolling devices exposes from the first layer to provide the system surface; and
a controlling device for controlling rotation of at least one of the rolling devices, thereby adjusting the system surface between slippery and non-slippery.

7. The surface system of claim 6, wherein the platform further comprises a third layer, wherein the controlling device for controlling the third layer to contact with at least one of the rolling devices to prevent the at least one of the rolling devices from turning around, thereby adjusting the system surface between slippery and non-slippery.

8. The surface system of claim 6, wherein the platform further comprises a third layer and a number of support beams coupled to the first, the second and the third layers, wherein the controlling device is for controlling the third layer moving along the support beams to contact with at least one of the rolling devices to prevent the at least one of the rolling devices from turning around, thereby adjusting the system surface between slippery and non-slippery.

9. The surface system of claim 6, wherein the platform further comprises a third layer which has a number of sections, each section being controlled independently by the controlling device to contact with at least one of the rolling devices to prevent the at least one of the rolling devices from turning around, thereby adjusting the system surface between slippery and non-slippery.

10. The surface system of claim 6, wherein the controlling device is one of a hydraulic system and a mechanical system.

11. A controllable surface system, comprising:
a platform providing a system surface with a surface friction, wherein the platform comprises:
a first layer with a first friction having a number of opening areas;
a second layer having a number of devices in positions corresponding to locations of the opening areas of the first layer, wherein each device has a surface with a second friction; and
a controlling device capable of controlling the second layer so that at least one of the devices is exposed from the open areas of the first layer, thereby adjusting the surface friction of the system surface.

12. The surface system of claim 11, wherein the platform further comprises a number of support beams coupled to the first and the second layers.

13. The surface system of claim 11, wherein the controlling device is one of a hydraulic system and a mechanical system.

14. The surface system of claim 11, wherein the second layer has a number of sections, each section is controlled by the controlling device to expose at least one of the devices from the open areas of the first layer.

15. The surface system of claim 1, wherein the platform comprises;
a number of rolling elements, each element has a covering arranged to provide at least two different degrees of friction, wherein the controlling device is for controlling rotation of each element to change the system surface from one friction to another.

16. The surface system of claim 1, wherein the system surface has a surface friction that is adjustable in accordance with external influences applying to the platform.

17. The surface system of claim 1, wherein the system surface has a surface friction that is adjustable in accordance with application of at least one of heat, electrical current, electromagnetic field and other types of energies.

18. A controllable surface system, comprising:
a platform providing a system surface with a surface friction, wherein the surface friction is adjusted in accordance with application of external influences; and
a controlling device for controlling an amount of the external influences that applies to the platform.

19. The surface system of claim 18, wherein external influences include at least one of heat, electrical current, and electromagnetic field.
